(19) United States
(12) Patent Application Publication
(10) Pub. No.: US 2006/0273261 A1
(43) Pub. Date: Dec. 7, 2006

(54) Laser scanning microscope

(76) Inventors: Ralf Wolleschensky, Apolda (DE); Wolfgang Bathe, Jena (DE); Frank Hecht, Weimar (DE); Ralf Engelmann, Jena (DE); Joerg Steinert, Jena (DE)

Correspondence Address: JACOBSON HOLMAN PLLC, 400 SEVENTH STREET N.W., SUITE 600, WASHINGTON, DC, 20004, US

(21) Appl. No.: 11/416,394

(22) Filed: May 3, 2006

(30) Foreign Application Priority Data
May 3, 2005 (DE) 10 2005 020 540.2

(51) Int. Cl. G01N 21/64

(52) U.S. Cl. 250/458.1

(57) ABSTRACT

A Laser Scanning Microscope with an illumination radiation distribution, which is guided over a sample for scanning and in which an image of the sample is taken from the sample radiation generated and detected during the scanning, wherein the sample is sampled with an imaging rate of x images per second, wherein in a mode for the adjustment of the device parameters, the imaging rate is reduced with uniform sampling speed. preferably for sparing the sample the exposure, to a fraction X/Y of X, Y>1.

### BACKGROUND OF THE INVENTION

1. Field Of The Invention

The invention relates to Laser Scanning Microscopes, in general, and to Laser Scanning Microscopes with an illumination radiation distribution, which is guided over a sample for scanning and in which an image of the sample is taken from the sample radiation generated and detected during the scanning, in particular.

2. Description Of The Related Art

In the prior state-of-the-art, use of a so-called “continuous scan” mode for setting all the important parameters for imaging in a microscope is well-known. In the “continuous scan” mode continuous images are taken and displayed (but not saved), with the aim of providing the user the option of observing a sample “online” in real time. Some examples of the desirability of this technique are in order to focus, to search for a position of interest in a sample, and for adjusting the illumination and the sensitivity of the microscope.

The sample is thereby subjected to heavy exposure, especially if the imaging rates are high with low integration time. The (fixed) ratio of the scanning time to the pause interval (reversal phases or return-scanning time of the scanner) is not tuned to the requirements of the sample.

### BRIEF SUMMARY OF THE INVENTION

The present invention relates to a Laser Scanning Microscope with an illumination radiation distribution, which is guided over a sample for scanning and in which an image of the sample is taken from the sample radiation generated and detected during the scanning. Included in the inventive Laser Scanning Microscope comprising is a device for sampling the sample with an imaging rate of x images per second. Another device reduces the imaging rate with uniform sampling speed, preferably for sparing the sample the exposure, to a fraction X/Y of X, Y>1 in a mode for the adjustment of the device parameters.

In the inventive Laser Scanning Microscope the illumination radiation distribution may be a line or a multipoint distribution. The illumination radiation distribution may also be generated by a Nipkow disk.

The Laser Scanning Microscope also includes structure for connecting signals between at least one controlling device of the microscope and the image. A way to take an image when a displacement is actuated is also provided.

In the inventive Laser Scanning Microscope, the controlling devices are the z-drive, and/or sample table and/or filter changer and/or pinhole setting and/or hardware or software side user presets and/or regulating buttons and/or switches.

Finally, in the inventive Laser Scanning Microscope, an image is taken, if a displacement is actuated in the microscope. In the display devices of the microscope, the last image taken respectively is displayed.

Particularly, in a very fast line scanner with imaging rates greater than 100 images per second during the adjustment of the microscope parameters, as described in the exemplary embodiment, imaging rates of even 25 images/second, or often even considerably lesser rates (5 images/second) are sufficient.

Of importance to the present invention is that, not the scanning rate itself is reduced as in the prior state-of-the-art, but that the pauses between the images are increased. This addresses a disadvantage of the prior art relating to a change in the integration time and influence on the parameters for the imaging. Advantageous thereby is that there are no disadvantages connected with the adjustment of the device parameters, yet the sample is subjected to less exposure.

This can be achieved in that separate adjustment for the integration time and the imaging rate (pause interval) is done, for instance, through separate slider regulators.

This can be achieved in that an automatic presetting of these values takes place, for example, a fixed preset value of 25 fpsec real time for the imaging rate for the eye or several other presets (25, 15, 5 fpsec) that can be selected by the user, in that, in case of continuing sweeps of the scanner, a switching off or reduction of the illumination wavelengths takes place, for example with the available AOTF, (see DE7223), whereby the scanner continues to operate unabated, or else with the stopping of the scanner between the scans.

In the case of a fast scan, it is advantageous if adequate settling time precedes the actual imaging. A further enhancement of the invention is as follows: Whenever there is an interaction with the user, a new image is taken, thus, for example, during: 1) a movement of the z-drive; 2) a movement of the sample table; and changes in the configuration (filter, pinhole, integration time, gain, etc.). The settings made by the user without direct interaction with the device (through software-aided switches, or, for example, by means of the usual operating buttons) can also trigger the mode according to the invention. In addition, a “refresh” button can be provided for this purpose.

This method can be advantageously combined with the reduced imaging rate described above in order to spare the sample and in particular to prevent fading during fluorescence examinations. Thus the system would take images only if the user actually makes a change.

According to the invention, it is then possible to wait for an (adjustable) period, until the illumination is interrupted or for the imaging after the end of the interaction, in order to also record possible reaction times, for example, of the sample. In the intervening periods, if the image always looks the same anyway, the image is not scanned. Thus, the illumination, and hence the damage to the sample, is minimized. The image scanned last time would still be there to see on the screen (which, since there is no change, would still correspond to the current status).

A typical sequence appears as in the following: 1) the user activates a so-called “Image on demand” mode (so far he activates a continuous scan) and optimizes the settings; 2) the user aborts the mode after completing the settings; 3) at this time, the last recorded image is still visible on the monitor; and 4) the system has discarded all images taken previously. The user can then store the last image if he wishes to do so.

### BRIEF DESCRIPTION OF THE DRAWING

FIG. 1 is a schematic diagram of a microscope incorporating the present invention.

### DETAILED DESCRIPTION OF THE INVENTION

In describing preferred embodiments of the present invention illustrated in the drawing, specific terminology is employed for the sake of clarity. However, the invention is not intended to be limited to the specific terminology so selected, and it is to be understood that each specific element includes all technical equivalents that operate in a similar manner to accomplish a similar purpose.

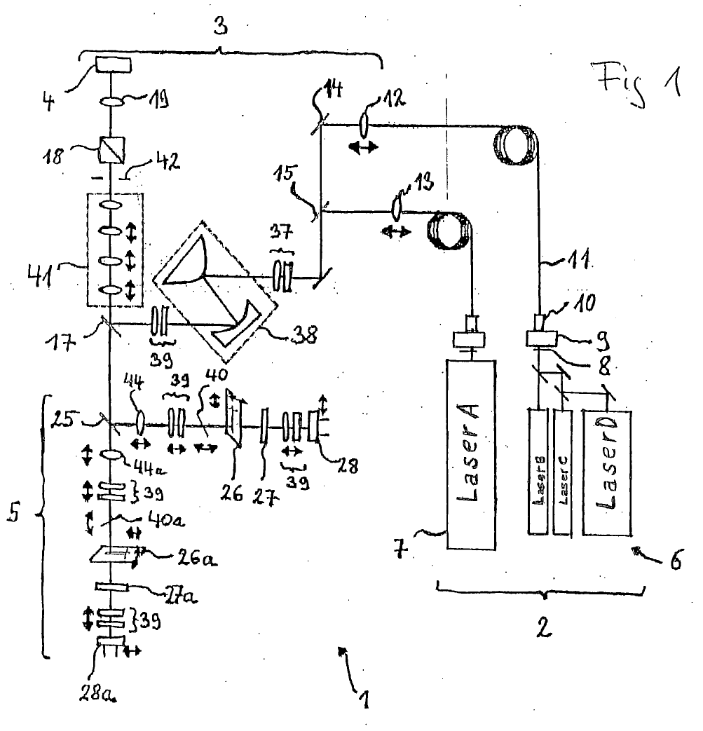

FIG. 1, the lone figure, shows schematically a Laser Scanning Microscope 1, which is essentially built from five components: a light source module 2, which generates the excitation radiation for the laser scanning microscopy, a scanning module 3, which conditions the excitation radiation and appropriately deflects it over the sample for scanning, a microscope module 4, shown only schematically for the sake of simplicity, which directs the scanning beam provided by the scan module in a microscopic beam path onto the sample, as well as a detector module 5, which receives and detects the optical radiation from the sample. The detector module 5 can thereby be designed for several spectral channels as shown in FIG. 1.

For the general description of a point-to-point scanning Laser Scanning Microscope, reference is made to U.S. Pat. No. 6,167,173 A, incorporated by reference herein in its entirety.

The radiation source module 2 generates the illumination beam, which is suitable for laser scanning microscopy, that is, in particular, a beam that can trigger fluorescence. For that purpose, the radiation source module is provided with several radiation sources depending on the application. In one of the embodiments shown, two lasers 6 and 7 are provided in the radiation source module 2, followed in each case by a light valve 8 as well as an attenuator 9 and which couple their radiation through a coupling point 10 into optical fiber 11. The light valve 8 acts as a beam deflector, which can serve the same purpose as a beam shutter, without necessitating thereby switching off of the operation of the laser in the laser unit 6 and/or 7 itself. The light valve 8 is designed, for instance, as an AOTF, which deflects the laser beam, for switching off the beam, before coupling into the optical fibers 11, in the direction of a light trap not shown here.

In the exemplary illustration in FIG. 1, the laser unit 6 comprises three lasers B, C, D, in contrast to which, the laser unit 7 has only one laser A. This illustration is thus an example of a combination of single-wavelength and multi-wavelength lasers, which are coupled individually or jointly to one or more fibers. The coupling can take place in several fibers at the same time, whose radiation is later mixed by a color combiner after passing through an adaptive optical system. It is thus possible to use a great diversity of wavelengths or wavelength ranges for the excitation radiation.

The radiation coupled in the optical fibers 11 is combined by means of displaceable collimation optics 12 and 13 through the beam combining mirrors 14, 15 and modified in regard to its beam profile in a beam-shaping unit.

The collimators 12, 13 serve the purpose of collimating the radiation, fed by the radiation source module 2 into the scan module 3, to an infinite beam. This is achieved with advantage in each case by using a single lens that has a focusing function, achieved through displacement along the optical axis, regulated by means of a central control unit (not shown here), whereby the distance between the collimator 12, 13 and the respective end of the optical fiber is changeable.

The beam-shaping unit, which is explained in greater detail later, generates, from rotation symmetrical laser beam with Gaussian profile, as it is present after the beam combining mirrors 14, 15, a line-shaped beam, which is no longer rotation symmetrical, but has a cross section that is suitable for generating a field with rectangular illumination.

This illumination beam, also said to be line-shaped, serves as the excitation radiation and is guided to a scanner 18 through a main dichroic beam splitter 17 and a zoom optic described later. The main dichroic beam splitter is described in greater detail later; suffice it to mention here that it has the function of separating the sample radiation returning from the microscope module 4 from the excitation radiation.

The scanner 18 deflects the line-shaped beam along one or two axes, after which it is bundled by a scanning objective 19 as well as a tube lens and an objective of the microscope module 4 onto a focus 22, which lies in a preparation or a sample. Thereby the optical imaging takes place in such a manner that the sample is illuminated by the excitation radiation over a caustic curve.

The fluorescence radiation excited with the line-shaped focus in this manner, returns, passing through the objective and the tube lens of the microscope module 4 and the scanning objective 19, back to the scanner 18, so that in the returning direction, after the scanner 18, there is again a static beam. Therefore the scanner 18 is also said to de-scan the fluorescence radiation.

The main dichroic beam splitter 17 lets the fluorescence radiation with wavelengths in a range other than the excitation radiation pass through, so that it is deflected by a deflecting mirror 24 in the detector module 5 and can thereupon be analyzed. In the embodiment as in FIG. 1, the detector module 5 has several spectral channels, that is, the fluorescence beam coming from the deflecting mirror 24 is split by a secondary dichroic beam splitter 25 into two spectral channels.

Each spectral channel has a slit diaphragm 26, which realizes a confocal or a partially confocal image with respect to the sample 23 and whose size determines the depth of focus with which the fluorescence beam can be detected. The geometry of the slit diaphragm 26 thus determines the plane of the cross section within the (thick) preparation, from which the fluorescence beam is detected.

Further, after the slit diaphragm 26, a block filter 27 is mounted, which blocks the undesirable excitation light entering into the detector module 5. The line-shaped, fanned out beam, separated in this manner, and which comes from a segment at a particular depth, is then analyzed by a suitable detector 28. Analogous to the described color channel, the second spectral detection channel is also built up in the same manner, which also comprises a slit diaphragm 26a, a block filter 27a, as well as a detector 28a.

The use of a confocal slit aperture in the detector module 5 is only an exemplary instance. Naturally, a single-point scanner can also be used. The slit diaphragms 26, 26a are in that case replaced by pinhole diaphragms and the beam-shaping unit can be dispensed with. Besides that, in such type of construction, all optical systems are embodied with rotational symmetry. Thus, obviously, instead of a single-point scanning and a single-point detection, in principle any arbitrary multipoint-arrangement, such as those with scatter plots or Nipkow disk concepts, can be employed. Of importance is, however, that the detector 28 performs spatial resolution, because parallel recording of several sample points takes place during the scanning cycle of the scanner.

In FIG. 1, the bundles of the beams, which have Gaussian profile after the movable, that is, displaceable collimators 12 and 13, are combined by means of a mirror staircase in the form of beam combining mirrors 14, 16, and are converted subsequently, in the shown embodiment with the confocal slit diaphragm, into a bundle of beams with rectangular beam cross section. In the embodiment in FIG. 1, a cylinder telescope 37 is used as the beam-shaping unit, after which an aspherical unit 38 is arranged in the subsequent path, followed by a cylindrical optical system 39.

After the transformation, a beam is obtained, which essentially illuminates a rectangular field in a profile plane, whereby the intensity distribution along the longitudinal axis of the field does not have a Gaussian but rather a step-like profile.

The arrangement for the illumination with the aspherical unit 38 can serve the purpose of uniform filling of a pupil between a tube lens and an objective. With that, the optical resolution of the objective can be fully utilized. This variant is thus also suitable in microscope systems with single-point or multipoint scanning, for example, in a line-scanning system (in the latter case additionally to the axis in which the focusing is done on or in the sample).

For example, the excitation radiation conditioned to the line-shape is deflected to the main dichroic beam splitter 17. The latter is embodied, in a preferred embodiment, as a spectrally neutral beam splitter according to U.S. Pat. No. 6,888,148 B2, whose disclosed content is incorporated herein to its full scope. Thus the term “color splitter” also includes non-spectrally acting splitter systems. In place of the described color splitters that are independent of the spectrum, a homogeneous neutral beam splitter (for example 50/50, 70/30, 80/20, or similar) or a dichroic beam splitter can also be employed. In order to enable the selection independent of the application, the main dichroic beam splitter is preferably provided with a mechanical arrangement, which enables easy replacement, for instance, by means of a corresponding beam splitter disk containing individual, exchangeable beam splitters.

It is to be understood that the present invention is not limited to the illustrated embodiments described herein. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1. A Laser Scanning Microscope with an illumination radiation distribution, which is guided over a sample for scanning and in which an image of the sample is aken from the sample radiation generated and detected during the scanning, the Laser Scanning Microscope comprising:
means for sampling the sample is sampled with an imaging rate of x images per second,
means for reducing the imaging rate with uniform sampling speed, preferably for sparing the sample the exposure, to a fraction X/Y of X, Y>1 in a mode for the adjustment of the device parameters.

2. The Laser Scanning Microscope according to claim 1, wherein the illumination radiation distribution is a line.

3. The Laser Scanning Microscope according to claim 1, wherein the illumination radiation distribution is a multipoint distribution.

4. The Laser Scanning Microscope according to claim 1, wherein the illumination radiation distribution is generated by a Nipkow disk.

5. The Laser Scanning Microscope according to claim 1, further comprising:
means for connecting signals between at least one controlling device of the microscope and the image; and
means for taking an image when a displacement is actuated.

6. The Laser Scanning Microscope according to claim 1, wherein the controlling devices are the z-drive, and/or sample table and/or filter changer and/or pinhole setting and/or hardware or software side user presets and/or regulating buttons and/or switches.

7. A method for operating a Laser Scanning Microscope, whereby an image is taken. if a displacement is actuated in the microscope.

8. The method according to claim 7. wherein in the display devices of the microscope, the last image taken respectively is displayed.
